(19) United States
(12) Patent Application Publication
(10) Pub. No.: US 2022/0009194 A1
(43) Pub. Date: Jan. 13, 2022

(54) BIONIC FIBER-REINFORCED COMPOSITE MATERIAL WITH HIGH IMPACT RESISTANCE AND THE PREPARATION METHOD THEREOF

(71) Applicant: JILIN UNIVERSITY, Changchun City (CN)

(72) Inventors: Qigang HAN, Changchun City (CN); Ruowei SHAO, Changchun City (CN); Zhiwu HAN, Changchun City (CN); Bo LI, Changchun City (CN)

(21) Appl. No.: 17/172,781

(22) Filed: Feb. 10, 2021

(30) Foreign Application Priority Data
Jul. 11, 2020 (CN) 202010665141.0

(51) Int. Cl. B32B 5/02; B32B 5/26; B32B 27/08; B32B 27/26; B32B 27/30; B29C 70/34; B29C 70/54

(52) U.S. Cl. CPC B32B 5/02; B29K 2025/00; B32B 27/08; B32B 27/26; B32B 27/302; B29C 70/34; B29C 70/54; B32B 2250/05; B32B 2264/1021; B32B 2262/08; B32B 2307/558; B32B 2307/514; B32B 2605/00; B29C 2791/002; B32B 5/26

(57) ABSTRACT

Disclosed is a bionic fiber-reinforced composite material with high impact resistance and a preparation method thereof. Bionic fiber composite material is composed of positive and negative spiral fiber resin layers, which are alternately laid in a particular proportion and then heated and cured under pressure. The positive and negative spiral fiber resin layers are non-coaxial and uniformly rotated and stacked along their respective central axes periodically. The bionic fiber resin layer is formed by infiltrating a structurally bionic fiber material with a modified resin. The bionic structures include a scorpion claw structure, a jaw foot structure of mantis shrimp and a combined structure in the horn sheath of small tail Han sheep and pheasant feathers. Significantly, bionic fiber-reinforced composite material effectively improves the impact resistance and interlayer toughness of the fiber composite material by undergoing the combinatorial bionics of the structure of fiber material and the layering method.

### CROSS-REFERENCE TO RELATED APPLICATION

This application claims priority to Chinese Patent Applications No. CN202010665141.0 filed on Jul. 11, 2020, which is hereby incorporated by reference in its entirety.

### FIELD OF THE INVENTION

The present disclosure belongs to the field of composite materials and mechanical engineering, and particularly relates to a bionic fiber-reinforced composite material with high impact resistance and the preparation method thereof.

### BACKGROUND

With the rapid development of aerospace, automobiles and rail transit, the requirements for lightweight and high-strength materials have become more urgent. Fiber-reinforced composite materials possess the characteristics of lightweight and quality mechanical properties. Thanks to these advantages, they are widely used in the field of modern engineering technology. However, due to the weaving and layering method of traditional fiber-reinforced composite material is relatively monotonous, the interlayer toughness is poor, making its impact resistance difficult to meet the demand of aircraft, high-speed rail and other high-speed vehicles. Therefore, one difficult problem in fiber composite design is to improve the impact resistance of composite materials and realize their lightweight at the same time.

Researchers find that some biological structures in nature have special properties such as collision resistance and impact resistance, including double spiral winding structures of the bamboo fiber possess the properties of tensile and compressive deformation resistance. Besides, the sine structure of the cuticle in the scorpion claw is shock resistant. Afterward, alternating positive and negative sine structures of chitin fiber in mantis shrimp jaw foot play the role of homogenizing stress and dissipating impact energy. Then, convex hull structure on the sheath of the small tail Han sheep horns can effectively prevent horns from cracking during a collision. What is more, the intermediate layer of pheasant feathers is hard, yet the outer layer is soft. This “soft and hard” structure has the characteristics of absorbing and rebounding impact energy.

Through bionic research on the structural characteristics of scorpions, mantis shrimp, small tail Han sheep and pheasants, they provide a consummate strategy for the structural design of fibers. Simultaneously, by combining the above biological structures with the biological structure of bamboo, it can provide an innovative laying method for the fiber resin layer.

### BRIEF SUMMARY OF THE DISCLOSURE

Aiming at the defects in traditional composite materials, the present disclosure provides a bionic fiber-reinforced composite material with high impact resistance and the preparation method thereof. Using the structurally bionic fiber materials and laying methods, the impact resistance and interlayer toughness are improved stupendously. Concerning the drawings in the specification, the technical scheme of the invention is as follows:

The bionic fiber-reinforced composite materials with high impact resistance are formed by alternately laying positive and negative spiral fiber resin layers, and then pressuring, heating and curing.

The positive and negative spiral fiber resin layers are arranged non-coaxially, and they are both rotated and stacked uniformly along their respective central axes.

The bionic fiber resin layer is prepared by infiltrating structurally bionic fiber materials with modified resin, wherein the structurally bionic fiber material is composed of sine fibers and straight fibers. The sine fibers are fibers with a sinusoidal shape.

Further, the modified resin is formed by mixing polyphenylene sulfide resin, reinforcing agent and silica particles.

Further, the positive and negative spiral fiber resin layers are the same or two different bionic fiber resin layers.

Further, the structurally bionic fiber material is a kind of fiber material inspired by a fiber structure in a scorpion claw, which is composed of unidirectional sine fibers and straight fibers.

The unidirectional sine fiber is composed of three layers of sine fibers with a same amplitude direction, and each layer is arranged perpendicular to its oscillation direction.

The straight fibers are wrapped on an outer side of the unidirectional sine fibers. Besides, the straight fibers are arranged perpendicular to the unidirectional sinusoidal fibers' oscillation direction and are wrapped on an outer side of each layer of sine fibers.

Further, the structurally bionic fiber material is a fiber material imitating a jaw-foot structure of mantis shrimp, and is composed of bidirectional sine fibers and bidirectional straight fibers.

The bidirectional sine fiber is composed of two groups of sine fibers with opposite amplitude directions, and the two groups of sine fibers cross each other in turn and are arranged perpendicular to their oscillation direction.

The bidirectional straight fibers are wrapped outside the bidirectional sine fibers. Besides, straight fibers are arranged perpendicular to an oscillation direction of the bidirectional sine fibers and are wrapped outside each layer of sine fibers.

Further, the structurally bionic fiber material is a fiber material with a combined structure imitating horn sheath of small tail Han sheep and pheasant feathers, which is composed of convex fibers, cross sine fibers and vertical convex short fibers.

The cross sine fiber comprises two groups of sine fibers whose oscillation directions are perpendicular to each other. Specifically, the two groups of sine fibers cross each other sequentially and are arranged perpendicular to their respective oscillation directions;

The convex fiber consists of the two groups of sinusoidal fibers of cross sine fibers, which are regarded as warp yarns and weft yarns, respectively. They are alternately woven in order to form a convex-hull structure fiber with a sinusoidal cross-section.

The vertical convex short fibers are arranged radially outside the convex fibers. What is more, a cross-sectional outer contour line of the vertical convex short fiber matches an outer contour curve of the convex fiber. And the vertical convex short fibers are wrapped outside the cross sine fibers.

Further, for the structurally bionic fiber material, a flexibility of a fiber wrapped outside is higher than that of a fiber wrapped inside, forming a structural feature of soft outside and hard inside.

Further, a rotation and stacking cycle of the positive and negative spiral fiber resin layer are 180°.

A plurality of laying ratios of the positive spiral fiber resin layer and the negative spiral fiber resin layer are 1:1, 1:2, 2:1, 1:3, or 3:1, respectively.

Further, a weight percentage content of fibers in the bionic fiber resin layer is 40% to 70%.

The preparation method of bionic fiber-reinforced composite material with high impact resistance is as follows:

Step 1: The structurally bionic fiber material is soaked in the modified resin to form a sine fiber resin layer;

Step 2: Taking several sine fiber resin layers as a group, the central axis between two groups of sine fiber resin layers are spaced apart, and then the two groups of sine fiber resin layers are arranged alternately in a certain ratio in sequence. During the laying process, one group of sine fiber resin layers sequentially rotates positively from top to bottom, and the other group sequentially rotates negatively from top to bottom. These two groups of sine fiber resin layers are arranged alternately and rotated in opposite directions to form a bidirectional spiral fiber resin layer;

Step 3: The resin layer comprising bidirectional spiral fiber is placed in the mold cavity and cured under the condition that the temperature is set to 50-300° C. and the pressure is set to 1-30 MPa. Besides, the curing time is 4-20 hours.

Compared with the traditional technique, the present disclosure possesses the following beneficial effects:

1. The bionic fiber resin layer in the present disclosure is composed of fiber material with a bionic structure inspired by scorpion claw, which significantly increases the strength of the fiber material in the thickness direction. Therefore, the impact resistance performance is improved by 140% compared with the traditional composite material.

2. The bionic fiber resin layer in the present disclosure is composed of fiber material imitating the jaw foot structure of mantis shrimp. While increasing the strength of the fiber material in the thickness direction, it rationally utilizes the function of sinusoidal fiber to equalize the stress so that its impact resistance is improved by about 200% compared with traditional composite materials, which realizes a medium impact resistance.

3. The bionic fiber resin layer in the present disclosure is composed of a fiber material with a combined structure imitating the horn sheath of small tail Han sheep and pheasant feathers, which effectively increases the strength of the fiber material in the thickness direction and plays a role in preventing the generation and propagation of cracks. Therefore, the impact resistance of bionic fiber-reinforced composite materials is about 400% higher than that of traditional composite materials, which realizes a high impact resistance.

4. The bionic fiber resin layer in the present disclosure is composed of soft and hard fiber materials, which significantly increases the toughness of the fiber resin layer.

5. The bionic fiber resin layer in the present disclosure employs a non-coaxial double spiral laying method, which can change the direction of cracks generated by the impact and enhance the interlayer toughness of the composite material.

### BRIEF DESCRIPTION OF THE DRAWINGS

FIG. 1a is a schematic diagram of a double spiral winding structure of the bamboo fiber.

FIG. 1b is a schematic diagram of the sine structure in the stratum corneum of a scorpion claw.

FIG. 1c is a schematic diagram of the alternate positive and negative sine structure of the mantis shrimp chitin fibers.

FIG. 1d is a schematic diagram of the convex structure in the horn sheath of the small tail Han sheep.

FIG. 1e is a schematic diagram of the “soft and hard” structure of pheasant feathers.

FIG. 2a is a schematic diagram of a 1:1 layered structure of the positive spiral fiber resin layer and the negative spiral fiber resin layer.

FIG. 2b is a schematic diagram of a 1:2 layered structure of the positive spiral fiber resin layer and the negative spiral fiber resin layer.

FIG. 2c is a schematic diagram of a 1:3 layered structure of the positive spiral fiber resin layer and the negative spiral fiber resin layer.

FIG. 2d is a schematic diagram of a 2:1 layered structure of the positive spiral fiber resin layer and the negative spiral fiber resin layer.

FIG. 2e is a schematic diagram of a 3:1 layered structure of the positive spiral fiber resin layer and the negative spiral fiber resin layer.

FIG. 3a is a schematic diagram of the fiber resin layer with a scorpion claw structure in an embodiment of the present disclosure.

FIG. 3b is a schematic diagram of the straight fibers in the fiber resin layer with a scorpion claw structure.

FIG. 3c is a schematic diagram of the unidirectional sine fibers in the fiber resin layer with a scorpion claw structure.

FIG. 4a is a schematic diagram of the fiber resin layer with a jaw foot structure of mantis shrimp in an embodiment of the present disclosure.

FIG. 4b is a schematic diagram of the straight fibers in the fiber resin layer with a jaw foot structure of mantis shrimp.

FIG. 4c is a schematic diagram of the bidirectional sine fibers in the fiber resin layer with a jaw foot structure of mantis shrimp.

FIG. 5a is a schematic diagram of the fiber resin layer with a combined structure imitating the horn sheath of small tail Han sheep and pheasant feathers in an embodiment of the present disclosure.

FIG. 5b is a schematic diagram of the convex fibers in the fiber resin layer with a combined structure imitating the horn sheath of small tail Han sheep and pheasant feathers.

FIG. 5c is a schematic diagram of the cross sine fibers in the fiber resin layer with a combined structure imitating the horn sheath of small tail Han sheep and pheasant feathers.

FIG. 5d is a schematic diagram of the vertical convex short fibers in the fiber resin layer with a combined structure imitating the horn sheath of small tail Han sheep and pheasant feathers.

In the drawings: 1—fiber resin layer with scorpion claw structure; 2—fiber resin layer with jaw foot structure of mantis shrimp; 3—fiber resin layer with a combined structure imitating the horn sheath of small tail Han sheep and pheasant feathers; 4—resin matrix; 11—straight fiber one; 12—unidirectional sine fiber; 21—straight fiber two; 22—bidirectional sine fiber; 31—convex fiber; 32—cross sine fiber; 33—vertical convex short fiber; 41—positive spiral fiber resin layer; 42—negative spiral fiber resin layer.

### DETAILED DESCRIPTION OF EMBODIMENTS

In order to make the abovementioned objects, features, and advantages of the present invention more comprehensible, specific embodiments of the present invention will be described in detail below with reference to the accompanying drawings.

An embodiment discloses a bionic fiber-reinforced composite material with high impact resistance and the preparation method thereof.

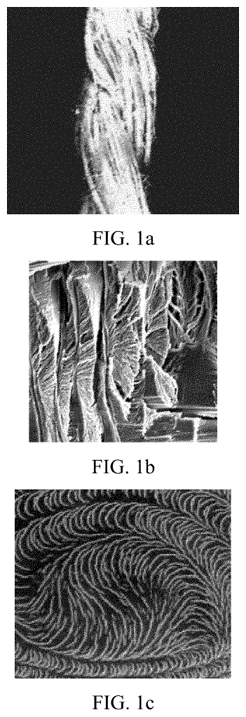

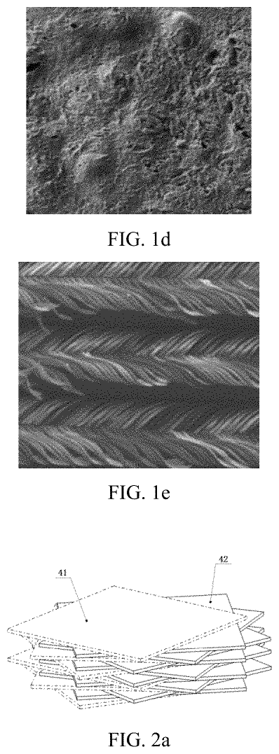

The laying structure in the present disclosure is a kind of bidirectional spiral winding structure inspired by bamboo fiber structure, as shown in FIG. 1a.

The bionic fiber-reinforced composite material is formed by alternately laying positive spiral fiber resin layers 41 and negative spiral fiber resin layers 42 in a certain ratio and then pressurizing, heating and curing.

The positive spiral fiber resin layer 41 and the negative spiral fiber resin layer 42 are both bionic fiber resin layers.

Wherein, taking the centerline perpendicular to the center of the positive spiral fiber resin layer 41 as the axis and taking 180° as a rotation period, the positive spiral fiber resin layers 41 are rotated positively by 36° sequentially, that is, the positive spiral fiber resin layer 41 takes five layers as a cycle; Taking the centerline perpendicular to the center of the negative spiral fiber resin layer 42 as the axis and taking 180° as a rotation period, the negative spiral fiber resin layers 42 are rotated positively by 36° sequentially, that is, the negative spiral fiber resin layer 42 takes five layers as a cycle; the rotation axis of the positive spiral fiber resin layer 41 is parallel to that of the negative spiral fiber resin layer 42, and the distance between these two rotation axes is 4 mm.

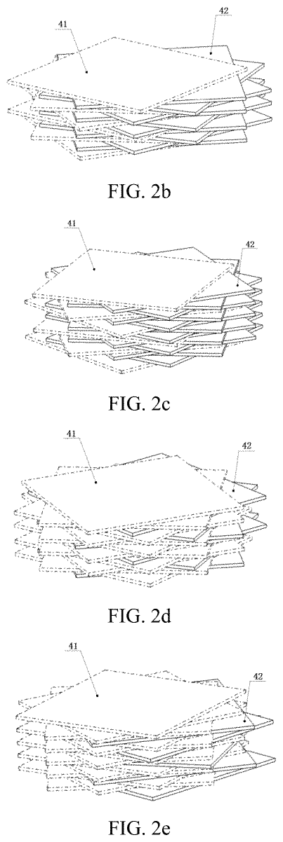

As shown in FIGS. 2a-2e, the laying ratios of the positive spiral fiber resin layer 41 and the negative spiral fiber resin layer 42 are 1:1, 1:2, 2:1, 1:3, and 3:1, respectively.

As shown in FIGS. 2a to 2c, one period of positive spiral fiber resin layer 41 and one to three periods of the negative spiral fiber resin layer 42 are alternately stacked to form one period of bidirectional spiral fiber resin layer;

As shown in FIGS. 2d and 2e, two to three cycles of positive spiral fiber resin layer 41 and one cycle of the negative spiral fiber resin layer 42 are alternately stacked to form a cycle of bidirectional spiral fiber resin layer;

The bionic fiber-reinforced composite material is formed by sequentially laying up a period of bidirectional spiral fiber resin layers and then pressurizing, heating and curing.

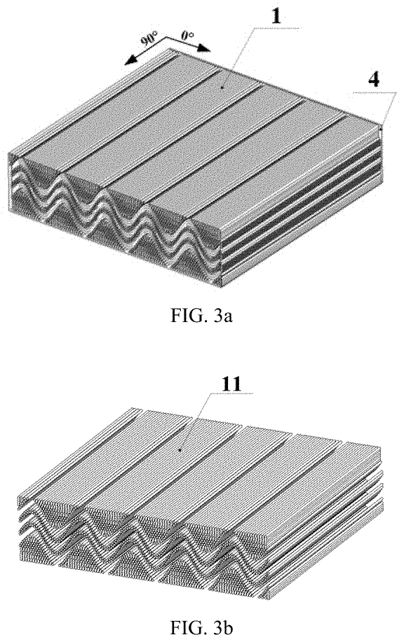

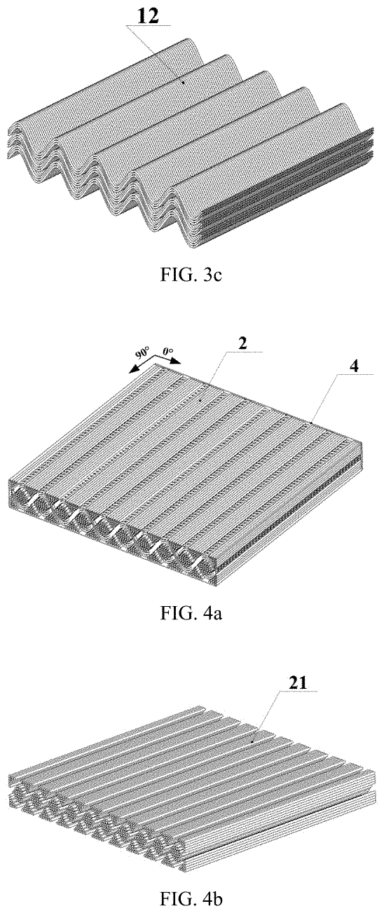

As shown in FIG. 3a, the bionic fiber resin layer is the fiber resin layer 1 with scorpion claw structure.

The bionic fiber resin layer 1 with the scorpion claw structure is prepared by impregnating structurally bionic fiber material with a modified resin.

The resin infiltrates the structurally bionic structural fiber material and fills the gaps to form resin Matrix 4. Besides, the thickness of the bionic fiber resin layer 3 is 1.2 mm, wherein:

The modified resin is prepared using polyphenylene sulfide (PPS) resin, reinforcing agent, and silica particles in a volume ratio of 8:2:1 through mechanically stirring.

As shown in FIGS. 3b and 3c, the weight percentage of the bionic structural fiber material in the bionic structural fiber resin layer is 68.8%.

As shown in FIG. 1b, the bionic structural fiber material is a kind of bionic structure based on the sine fiber structure in the stratum corneum of scorpion claw. The sine fibers are fibers with a sinusoidal shape.

The bionic structural fiber material is composed of straight fiber one 11 and unidirectional sine fiber 12.

The straight fiber one 11 is a Kevlar fiber with a linear shape and relatively high flexibility; the unidirectional sine fiber 12 is composed of three layers of sine fibers, whose oscillation directions are the same, and each layer of sine fibers is composed of a plurality of sine fibers arranged perpendicular to the oscillation direction; the amplitude of the sine fibers is 0.2 mm and the oscillation period is 4 mm; the unidirectional sine fibers are carbon fibers with relatively low flexibility.

The unidirectional sine fibers 12 are laid on the middle position of the bionic fiber resin layer 3; the straight fiber ones 11 are laid perpendicular to the oscillation direction of the unidirectional sine fibers 12, and wrapped outside the unidirectional sinusoidal fibers 12; the straight fiber ones 11 are sandwiched between every two layers of sine fibers so that the straight fiber one 11 is wrapped outside each layer of sine fibers to form a covering structure with hard inside and soft outside.

The preparation method of the bionic fiber-reinforced composite material is as follows:

Step 1: The fiber material with a bionic structure inspired by scorpion claw is immersed in modified resin to form a bionic structural fiber resin layer.

Step 2: Five bionic structural fiber resin layers are regarded as a group; The centerlines of two groups of bionic structural fiber resin layers are spaced 4mm apart; Two groups of sine fiber resin layers are arranged alternately. During the laying process, one group of bionic fiber resin layers sequentially rotates positively from top to bottom by 36°, and the other group sequentially rotates negatively from top to bottom by 36°. These two groups of bionic fiber resin layers are arranged alternately and rotated in opposite directions to form a bidirectional spiral fiber resin layer.

Step 3: Three groups of bidirectional spiral fiber resin layers are laid from top to bottom into the mold cavity, and cured under the condition that the temperature is set to 120° C. and the pressure is set to 20 MPa. Besides, the curing time is 4 hours to obtain the bionic fiber-reinforced composite material .

In the present embodiment, the unidirectional sinusoidal fibers 12 in the bionic structural fiber resin layer 3 are inspired by the sine structure in the stratum corneum of the scorpion claw, which has the effect of equalizing stress and dissipating impact energy; The straight fiber one 11 with higher flexibility is wrapped on the outer side of the unidirectional sinusoidal fiber 12 with lower flexibility to enhance the strength of the material and increase the impact energy absorption; The bidirectional spiral fiber resin layer adopts the double spiral winding structure inspired from the bamboo fiber material. The bionic structure is resistant to compression and deformation.

Another embodiment discloses a bionic fiber-reinforced composite material with high impact resistance and the preparation method thereof.

The laying structure in the present disclosure is a kind of bidirectional spiral winding structure inspired by bamboo fiber structure, as shown in FIG. 1a.

The bionic fiber-reinforced composite material is formed by alternately laying positive spiral fiber resin layers 41 and negative spiral fiber resin layers 42 in a certain ratio and then pressurizing, heating and curing.

The positive spiral fiber resin layer 41 and the negative spiral fiber resin layer 42 are both bionic fiber resin layers.

Wherein, taking the centerline perpendicular to the center of the positive spiral fiber resin layer 41 as the axis and taking 180° as a rotation period, the positive spiral fiber resin layers 41 are rotated positively by 36° sequentially, that is, the positive spiral fiber resin layer 41 takes five layers as a cycle; Taking the centerline perpendicular to the center of the negative spiral fiber resin layer 42 as the axis and taking 180° as a rotation period, the negative spiral fiber resin layers 42 are rotated positively by 36° sequentially, that is, the negative spiral fiber resin layer 42 takes five layers as a cycle; the rotation axis of the positive spiral fiber resin layer 41 is parallel to that of the negative spiral fiber resin layer 42, and the distance between these two rotation axes is 4 mm.

As shown in FIGS. 2a-2e, the laying ratios of the positive spiral fiber resin layer 41 and the negative spiral fiber resin layer 42 are 1:1, 1:2, 2:1, 1:3, and 3:1, respectively.

As shown in FIGS. 2a to 2c, one period of positive spiral fiber resin layer 41 and one to three periods of the negative spiral fiber resin layer 42 are alternately stacked to form one period of bidirectional spiral fiber resin layer;

As shown in FIGS. 2d and 2e, two to three cycles of positive spiral fiber resin layer 41 and one cycle of the negative spiral fiber resin layer 42 are alternately stacked to form a cycle of the bidirectional spiral fiber resin layer.

The bionic fiber-reinforced composite material is formed by sequentially laying up a period of bidirectional spiral fiber resin layers and then pressurizing, heating and curing.

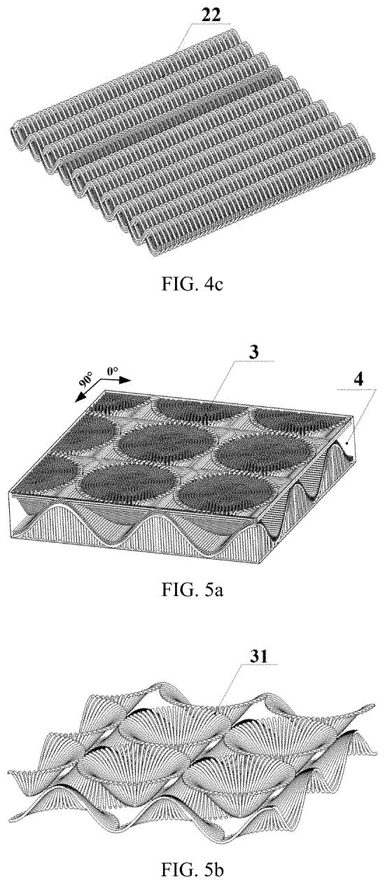

As shown in FIG. 4a, the bionic fiber resin layer is the fiber resin layer 2 inspired by the jaw foot structure of mantis shrimp.

The bionic fiber resin layer 2 with jaw foot structure of mantis shrimp is prepared by impregnating structurally bionic fiber material with a modified resin. The resin infiltrates the bionic structural fiber material and fills the gaps to form resin Matrix 4. Besides, the thickness of the bionic fiber resin layer 2 is 0.8 mm, wherein:

The modified resin is prepared using polyphenylene sulfide (PPS) resin, reinforcing agent, and silica particles in a volume ratio of 8:2:1 through mechanically stirring.

As shown in FIGS. 4b and c, the weight percentage of the bionic structural fiber material in the bionic structural fiber resin layer is 50%.

As shown in FIG. 1c, the structurally bionic fiber material is prepared imitating the alternating arrangement of positive and negative sine chitin fiber in the jaw foot of mantis shrimp.

The bionic structural fiber material is composed of straight fiber two 21 and bidirectional sine fiber 22.

The straight fiber two 21 is a Kevlar fiber with a linear shape and relatively high flexibility; The bidirectional sine fiber 22 is composed of alternately arranged positive sine fibers and negative sine fibers. The laying direction of bidirectional sine fiber 22 is perpendicular to the oscillation direction of positive and negative sine fibers. The amplitude of the bidirectional sine fibers is 0.2 mm and the oscillation period is 2 mm; The unidirectional sine fibers are carbon fibers with relatively low flexibility.

The bidirectional sine fibers 22 are laid on the middle position of the bionic fiber resin layer 2; the straight fiber twos 21 are laid perpendicular to the oscillation direction of the bidirectional sine fibers 22, and wrapped outside the bidirectional sine fibers 22; The straight fiber twos 21 are sandwiched between the positive and negative sine fibers of bidirectional sine fibers so that the straight fiber two 21 is wrapped outside each layer of bidirectional sine fibers to form a covering structure with hard inside and soft outside.

The preparation method of the bionic fiber-reinforced composite material is as follows:

Step 1: The fiber material with a bionic structure inspired by jaw foot structure of mantis shrimp is immersed in modified resin to form a bionic structural fiber resin layer.

Step 2: Five bionic structural fiber resin layers are regarded as a group; The centerlines of two groups of bionic structural fiber resin layers are spaced 4mm apart; Two groups of bionic sine fiber resin layers are arranged alternately. During the laying process, one group of bionic fiber resin layers sequentially rotates positively from top to bottom by 36°, and the other group sequentially rotates negatively from top to bottom by 36°. These two groups of bionic fiber resin layers are arranged alternately and rotated in opposite directions to form a bidirectional spiral fiber resin layer.

Step 3: Two groups of bidirectional spiral fiber resin layers are laid from top to bottom into the mold cavity, and cured under the condition that the temperature is set to 120° C. and the pressure is set to 20 MPa. Besides, the curing time is 4 hours to obtain the bionic fiber-reinforced composite material.

In the present embodiment, the bidirectional sine fibers 22 in the bionic structural fiber resin layer 2 are inspired by sine chitin fiber in the jaw foot of mantis shrimp, which has the effect of equalizing stress and dissipating impact energy; The straight fiber two 21 with higher flexibility is wrapped on the outer side of the bidirectional sine fiber 22 with lower flexibility to enhance the strength of the material and increase the impact energy absorption; The bidirectional spiral fiber resin layer adopts the double spiral winding structure inspired from the bamboo fiber material. The bionic structure is resistant to compression and deformation.

Another embodiment discloses a bionic fiber-reinforced composite material with high impact resistance and the preparation method thereof.

The laying structure in the present disclosure is a kind of bidirectional spiral winding structure inspired by bamboo fiber structure, as shown in FIG. 1a.

The bionic fiber-reinforced composite material is formed by alternately laying positive spiral fiber resin layers 41 and negative spiral fiber resin layers 42 in a certain ratio and then pressurizing, heating and curing.

The positive spiral fiber resin layer 41 and the negative spiral fiber resin layer 42 are both bionic fiber resin layers.

Wherein, taking the centerline perpendicular to the center of the positive spiral fiber resin layer 41 as the axis and taking 180° as a rotation period, the positive spiral fiber resin layers 41 are rotated positively by 36° sequentially, that is, the positive spiral fiber resin layer 41 takes five layers as a cycle; Taking the centerline perpendicular to the center of the negative spiral fiber resin layer 42 as the axis and taking 180° as a rotation period, the negative spiral fiber resin layers 42 are rotated positively by 36° sequentially, that is, the negative spiral fiber resin layer 42 takes five layers as a cycle; The rotation axis of the positive spiral fiber resin layer 41 is parallel to that of the negative spiral fiber resin layer 42, and the distance between these two rotation axes is 4 mm.

As shown in FIGS. 2a-2e, the laying ratios of the positive spiral fiber resin layer 41 and the negative spiral fiber resin layer 42 are 1:1, 1:2, 2:1, 1:3, and 3:1, respectively.

As shown in FIGS. 2a to 2c, one period of positive spiral fiber resin layer 41 and one to three periods of the negative spiral fiber resin layer 42 are alternately stacked to form one period of bidirectional spiral fiber resin layer; As shown in FIGS. 2d and e, two to three cycles of positive spiral fiber resin layer 41 and one cycle of the negative spiral fiber resin layer 42 are alternately stacked to form a cycle of the bidirectional spiral fiber resin layer.

The bionic fiber-reinforced composite material is formed by sequentially laying up a period of bidirectional spiral fiber resin layers and then pressurizing, heating and curing.

The bionic fiber resin layer 3 with a combined structure imitating the horn sheath of small tail Han sheep and pheasant feathers is prepared by impregnating structurally bionic fiber material with a modified resin. The resin infiltrates the bionic structural fiber material and fills the gaps to form resin Matrix 4. Besides, the thickness of the bionic fiber resin layer 1 is 0.6 mm, wherein:

The modified resin is prepared using polyphenylene sulfide (PPS) resin, reinforcing agent, and silica particles in a volume ratio of 8:2:1 through mechanically stirring.

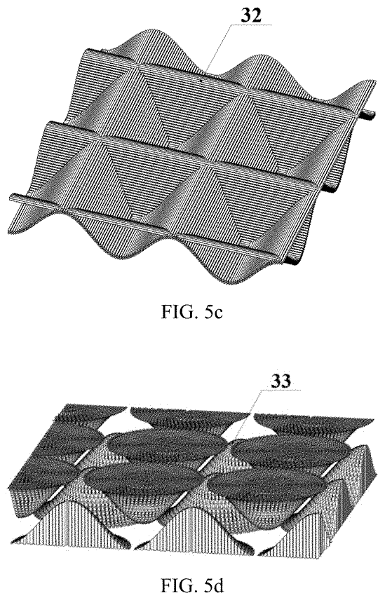

As shown in FIGS. 5b-5d, the weight percentage of the bionic structural fiber material in the bionic structural fiber resin layer is 43.5%.

As shown in FIGS. 1d and 1e, the structurally bionic fiber material is prepared imitating the combined structure of the convex hull structure in the horn sheath of small tail Han sheep and the “hard inside and soft outside” structure of pheasant feathers.

The bionic structural fiber material is composed of convex fiber 31, cross sine fiber 32 and vertical convex short fiber 33.

The cross sine fiber 32 is composed of alternately arranged transverse and longitudinal sine fibers, whose oscillation directions are perpendicular to each other. The transverse sine fibers and longitudinal sine fibers are laid perpendicular to their respective oscillation directions. The transverse and longitudinal fibers of the cross sine fibers 32 have an amplitude of 0.4 mm and an oscillation period of 4 mm. Besides, the cross sine fibers 32 are carbon fibers with relatively low flexibility.

The cross sine fiber 32 is laid on the middle position of the fiber resin layer 3 with a combined structure imitating the horn sheath of small tail Han sheep and pheasant feathers. The convex fiber 31 utilizes the longitudinal sine fiber of the cross sine fiber 32 as warp yarns and transverse sine fiber of the cross sine fiber 32 as weft yarns, forming a convex hull structure with a sinusoidal cross-section. The amplitude of the cross-section of the convex fiber 31 is 0.4 mm and the oscillation period is 4 mm. The convex position of the convex fiber 31 corresponds to the position where the wave peak of the transverse sinusoidal intersects with the wave peak of the longitudinal sinusoidal fiber, or corresponds to the position where the wave trough of the transverse sinusoidal fiber intersects with the wave trough of the longitudinal sinusoidal fiber. Therefore, the protrusions of the convex fiber 31 are laid and woven with cross sine fibers 32 in a spiral shape to make convex fiber 31 lay on the side of cross sine fibers 32.

The vertical convex short fibers 33 are arranged radially outside the convex fibers 31. Besides, the outer contour curve of the vertical convex short fibers 33 matches the outer contour curve of the convex fibers 31, that is, the outer contour line of the cross-section of the vertical convex short fiber 33 is a sine curve with an amplitude of 0.4 mm and an oscillation period of 4 mm.

The vertical convex short fiber 33 wraps the convex fiber 31 and the cross sine fiber 32 to form a coating structure with hard inside and soft outside.

The preparation method of the bionic fiber-reinforced composite material is as follows:

Step 1: The fiber material with a combined structure inspired from the horn sheath of small tail Han sheep and pheasant feathers is immersed in modified resin to form a bionic structural fiber resin layer.

Step 2: Five bionic structural fiber resin layers are regarded as a group; The centerlines of two groups of bionic structural fiber resin layers are spaced 4 mm apart; Two groups of bionic sine fiber resin layers are arranged alternately. During the laying process, one group of bionic fiber resin layers sequentially rotates positively from top to bottom by 36°, and the other group sequentially rotates negatively from top to bottom by 36°. These two groups of bionic fiber resin layers are arranged alternately and rotated in opposite directions to form a bidirectional spiral fiber resin layer.

Step 3: One group of convex spiral fiber resin layers is laid into the mold cavity, and cured under the condition that the temperature is set to 120° C. and the pressure is set to 20 MPa. Besides, the curing time is 4 hours to obtain the bionic fiber-reinforced composite material.

In the present embodiment, the cross sine fibers 32 in the bionic structural fiber resin layer 3 are inspired by a combined structure of the horn sheath of small tail Han sheep and pheasant feathers, which has the effect of equalizing stress and dissipating impact energy; The convex fiber 31 and the vertical convex short fiber 33 are bionic structures imitating the convex hull structure in the horn sheath of small tail Han sheep to effectively prevent the generation and propagation of cracks during the collision. The vertical convex short fiber 33 with higher flexibility is wrapped on the outer side of the convex fiber 31 and cross sine fiber 32 with lower flexibility, forming a “soft and hard” bionic structure imitating pheasant feathers, which can absorb and rebound impact energy. The bidirectional spiral fiber resin layer adopts the double spiral winding structure inspired by the bamboo fiber material, which is resistant to compression and deformation.

While the disclosure has been described with reference to an exemplary embodiment(s), it will be noted that the embodiment(s) is/are merely exemplary and not intended to limit the present disclosure. It will be understood by those skilled in the art that various changes may be made and equivalents may be substituted for elements thereof without departing from the scope of the disclosure.

In addition, it is intended that the disclosure not be limited to the particular embodiment(s) but that the disclosure will include all embodiments with any modifications or transformations falling within the scope of the appended claims.

What is claimed is:

1. Bionic fiber-reinforced composite material with high impact resistance, wherein:
positive and negative spiral fiber resin layers are alternately laid in a particular proportion and then heated and cured under pressure, the positive and negative spiral fiber resin layers are biomimetic fiber resin layers;
the positive and the negative bionic spiral fiber resin layers are non-coaxial and uniformly rotated and stacked along their respective central axes periodically;
the biomimetic fiber resin layers are formed by infiltrating a structurally bionic fiber material with a modified resin;
the structurally bionic fiber material is composed of sine fibers and straight fibers.

2. The biomimetic fiber-reinforced composite material with high impact resistance according to claim 1, wherein:
the modified resin is formed by mixing polyphenylene sulfide resin, reinforcing agent and silica particles.

3. The biomimetic fiber-reinforced composite material with high impact resistance according to claim 1, wherein:
the positive and negative spiral fiber resin layers are a same kind of bionic fiber resin layer or two different bionic fiber resin layers.

4. The biomimetic fiber-reinforced composite material with high impact resistance according to claim 1, wherein:
the structurally bionic fiber material is a fiber material with a scorpion chelate-like structure, which is composed of unidirectional sine fibers and straight fibers;
each of the unidirectional sine fiber is composed of three layers of sine fibers with a same amplitude direction, and each layer of the sine fibers is arranged perpendicular to its oscillation direction;
the straight fibers are coated outside the unidirectional sine fibers and are arranged perpendicular to the oscillation direction of the unidirectional sine fibers.

5. The biomimetic fiber-reinforced composite material with high impact resistance as according to claim 1, wherein:
the structurally bionic fiber material is a fiber material with a mantis shrimp jaw-foot structure, which is composed of bidirectional sine fibers and straight fibers;
each of the bidirectional sine fiber is composed of two groups of sine fibers with opposite amplitude directions, and the two groups of sine fibers are arranged to cross each other and perpendicular to their oscillation direction;
the bidirectional straight fibers are wrapped outside the bidirectional sine fibers, besides, the straight fibers are arranged perpendicular to the oscillation direction of the bidirectional sinusoidal fibers.

6. The biomimetic fiber-reinforced composite material with high impact resistance according to claim 1, wherein:
the structurally bionic fiber material is a fiber material with a combined structure of a horn sheath of small tail Han sheep and pheasant feathers, which is composed of convex fibers, cross sine fibers and vertical convex short fibers;
the cross sine fibers are composed of two sets of sine fibers, which cross each other in turn and are arranged perpendicular to their respective oscillation directions;
the convex fibers are woven with the set of the cross sine fibers as warp yarns and another set of the cross sine fibers as weft yarns, which form a cross-section with a sinusoidal curve shape;
the vertical convex short fibers are short fibers and are arranged radially outside the convex fibers in a bundle way an outer contour line of the vertical convex short fibers and convex fibers coincide with each other;
the vertical convex short fibers are wrapped outside the cross sine fibers and the convex fibers.

7. The biomimetic fiber-reinforced composite material with high impact resistance according to claim 4, wherein:
in the structurally bionic fiber material, a flexibility of fibers wrapped outside is higher than that of fibers wrapped inside.

8. The biomimetic fiber-reinforced composite material with high impact resistance according to claim 5, wherein:
in the structurally bionic fiber material, a flexibility of fibers wrapped outside is higher than that of fibers wrapped inside.

9. The biomimetic fiber-reinforced composite material with high impact resistance according to claim 6, wherein:
in the structurally bionic fiber material, a flexibility of fibers wrapped outside is higher than that of fibers wrapped inside.

10. The biomimetic fiber-reinforced composite material with high impact resistance according to claim 1, wherein:
a rotation and stacking cycle of the positive and negative spiral fiber resin layers is 180°;
the positive and negative spiral fiber resin layers have layering ratios of 1:1, 1:2, 2:1, 1:3, or 3:1, respectively.

11. The biomimetic fiber-reinforced composite material with high impact resistance according to claim 1, wherein:
in the bionic fiber resin layer, a weight percentage of fiber content is 40% to 70%.

12. A preparation method of the biomimetic fiber-reinforced composite material with high impact resistance according to claim 1, wherein:
the preparation method comprising:
step 1: immersing the structurally bionic fiber material into the modified resin to form a sine fiber resin layer;
step 2: taking several sine fiber resin layers as a group and spacing central axis between two groups of sine fiber resin layers, then the two groups of sine fiber resin layers are arranged alternately in a specific ratio, during a laying process, one group of sine fiber resin layers rotates positively from top to bottom, the other group of sine fiber resin layers rotates negatively from top to bottom, the two groups of sine fiber resin layers rotate alternately in opposite directions forming a double spiral fiber resin layer;
step 3: putting the double spiral fiber resin layer into a mold cavity and curing the double spiral fiber resin layer at 50-300° C. and under a pressure of 1-30 MPa, a curing time is 4-20 hours.
